(19) United States
(12) Patent Application Publication
(10) Pub. No.: US 2006/0050174 A1
(43) Pub. Date: Mar. 9, 2006

(54) Electronic apparatus with cover for protecting image capture device

(75) Inventor: Yung-Tsun Hsieh, Changhua (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/219,780

(22) Filed: Sep. 7, 2005

(30) Foreign Application Priority Data
Sep. 8, 2004 (TW) 93127108

(51) Int. Cl. H04N 5/225

(52) U.S. Cl. 348/373

(57) ABSTRACT

An electronic apparatus with a cover for protecting an image capture device. The electronic apparatus includes a body and a cover. The body includes an image capture device. The cover is connected to the body to be moveable between a first position and a second position. When the cover is in the first position, the image capture device is covered by the cover. When the cover is in the second position, the image capture device is exposed by the cover.

### BACKGROUND

The invention relates to electronic apparatuses, and in particular, to electronic apparatuses with a cover for protecting an image capture device thereof.

Recently, many handheld electronic apparatuses, such as mobile phones, comprise image capture devices therein. Since the handheld electronic apparatus is often placed in a pocket or purse to be easily carried, an exposed lens of the image capture device is easily damaged.

### SUMMARY

Electronic apparatuses are provided. An exemplary embodiment of an electronic apparatus comprises a body and a cover. The body comprises an image capture device. The cover is connected to the body to be moveable between a first position and a second position. When the cover is in the first position, the image capture device is covered by the cover. When the cover is in the second position, the image capture device is exposed by the cover.

Some embodiments of an electronic apparatus further comprise a hinge disposed in the cover to pass through the body so that the cover is moveable with respect to the body. The cover comprises a first housing and a second housing connected to the first housing via the hinge. The first housing comprises a first upper case, and the second housing comprises a second upper case connected to the first upper case via the hinge. The first upper case comprises a first hole. The second upper case comprises a second hole. The hinge comprises a head portion located in the first hole and a body portion located in the second hole. The second upper case comprises a rotary shaft in which the second hole is formed. The body comprises a third hole in which the rotary shaft is located. The hinge provides torsional force to move the cover toward the second position.

Additionally, the body comprises a first groove and a second groove. The first upper case comprises a first rod located in the first groove. The second upper case comprises a second rod located in the second groove. The cover is moveable between the first position and the second position by movement of the first and second rods in the first and second grooves respectively. The body comprises a first protrusion in the first groove and a second protrusion in the second groove to limit the first and second rods in the first position.

Moreover, the first housing further comprises a first lower case combined with the first upper case. The second housing further comprises a second lower case combined with the second upper case. The first and second lower cases are disposed on the same surface as the image capture device. The electronic apparatus further comprises a first spring, a second spring and two screws. The first spring is disposed between the first lower case and the body to move the first lower case toward the second position. The second spring is disposed between the second lower case and the body to move the second lower case toward the second position. Each of the first and second upper cases comprises a post. Each of the first and second lower cases comprises a guide hole. The first and second upper cases are combined with the first and second lower cases by the screws entering the post through the guide hole respectively.

Furthermore, the body comprises a display. The first and second upper cases are disposed on the same surface as the display. The first and second upper cases are formed in a manner such that the display is exposed by the first and second upper cases when the cover is in the first position.

Some embodiments of an electronic apparatus comprise an elastic member disposed between the cover and the body to move the cover toward the second position. The elastic member may be a compression spring.

Note that the electronic apparatus may be a mobile phone.

### DESCRIPTION OF THE DRAWINGS

The invention can be more fully understood by reading the subsequent detailed description and examples with references made to the accompanying drawings, wherein:

FIGS. 1a-1b are schematic views of an embodiment of an electronic apparatus;

FIG. 2 is an exploded view of the electronic apparatus in FIG. 1;

FIG. 3 is a schematic view of a first upper case, a second upper case, and a hinge in FIG. 2;

FIG. 4 is a schematic view of a body and a cover in FIG. 2, wherein the first and second upper cases are combined with the body;

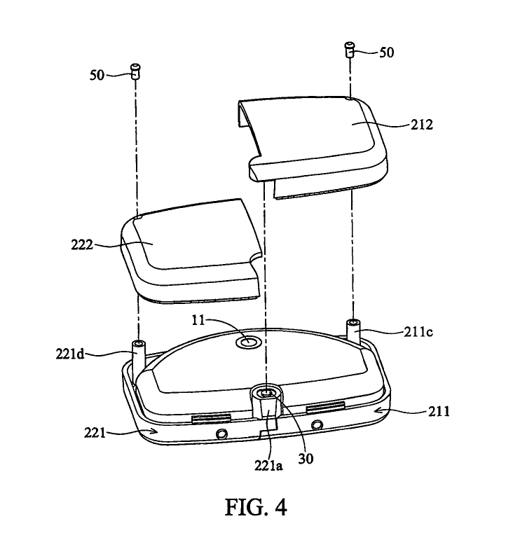

FIGS. 5a-5b are schematic views of the electronic apparatus, wherein the cover is in a second position;

FIG. 6 is a schematic view of another embodiment of an electronic apparatus, wherein a protrusion is formed in a groove; and

FIGS. 7a-7b are schematic views of another embodiment of an electronic apparatus, wherein a spring is disposed between a body and a cover.

### DETAILED DESCRIPTION

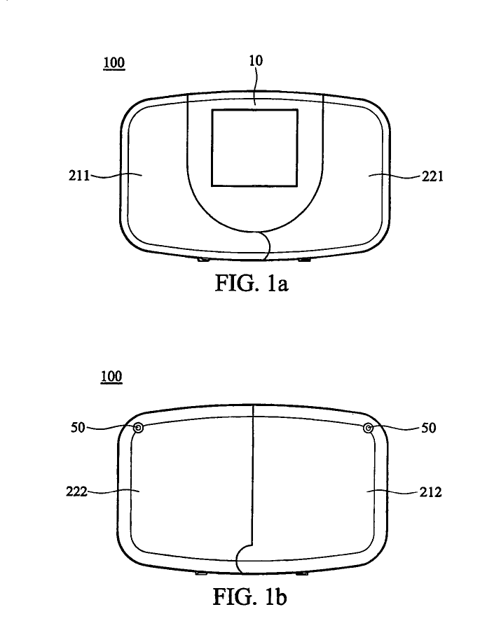

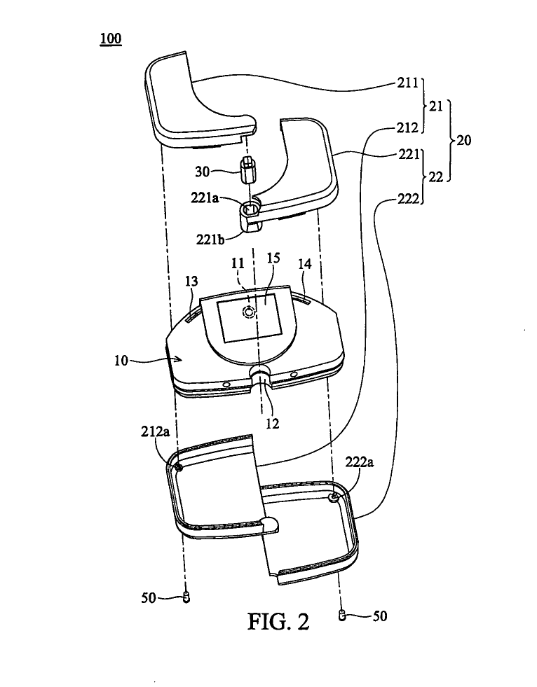

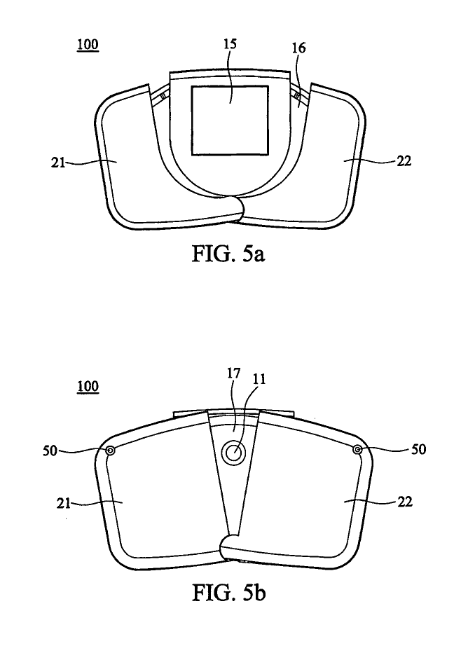

FIGS. 1a, 1b and 2 depict an embodiment of an electronic apparatus 100 comprising a body 10, a cover 20, a hinge 30, and two screws 50. The body 10 is a main portion of the electronic apparatus 100, and comprises electronic devices required by the electronic apparatus 100. The body 10 further comprises a third hole 12, a first surface 16, and a second surface 17 opposite to the first surface 16, as shown in FIGS. 5a and 5b. Also, the body 10 comprises an image capture device 11 on the second surface 17, and a display 15 on the first surface 16. A first groove 13 and a second groove 14 are formed at opposite sides of the display 15.

The cover 20 is connected to the body 10 via the hinge 30 to be moveable between a closed position (shown in FIGS. 1a and 1b and hereinafter referred to as a first position) and an open position (shown in FIGS. 5a and 5b and hereinafter referred to as a second position). Furthermore, the cover 20 comprises a first housing 21 and a second housing 22.

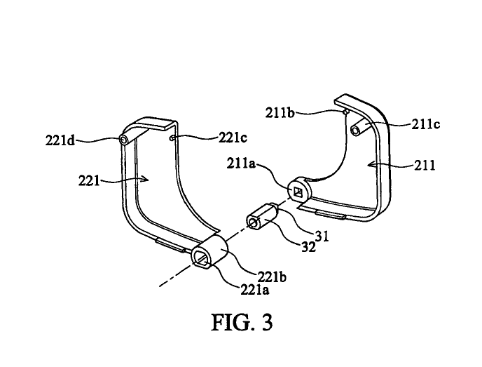

As shown in FIG. 2, the first housing 21 comprises a first upper case 211 and a first lower case 212 combined with the first upper case 211. The first upper case 211 is located on the first surface 16 of the body 10, and comprises a first hole 211a, a first rod 211b, and a post 211c, as shown in FIG. 3. The first rod 211b is located in the first groove 13 of the body 10. The first upper case 211 moves between the first position and the second position by movement of the first rod 211b in the first groove 13. Additionally, the first lower case 212 is located on the second surface 17 of the body 10, and comprises a guide hole 212a, as shown in FIG. 2. The first upper case 211 is combined with the first lower case 212 by the screw 50 entering the post 211c via the guide hole 212a.

As shown in FIG. 2, the second housing 22 comprises a second upper case 221 and a second lower case 222 combined with the second upper case 221. The second upper case 221 is located on the first surface 16 of the body 10, and comprises a second hole 221a, a rotary shaft 221b, a second rod 221c, and a post 221d, as shown in FIG. 3. The second hole 221a is formed in the rotary shaft 221b located in the third hole 12 of the body 10. The second rod 221c is located in the second groove 14 of the body 10. The second upper case 221 moves between the first position and the second position by movement of the second rod 221b in the second groove 14. Additionally, the second lower case 222 is located on the second surface 17 of the body 10, and comprises a guide hole 222a, as shown in FIG. 2. The second upper case 221 is combined with the second lower case 222 by the screw 50 entering the post 221d via the guide hole 222a.

Note that the first and second upper cases 211 and 212 are shaped in a manner such that the display 15 is exposed by the first and second upper cases 211 and 212 when the cover 20 is in the first position, as shown in FIG. 1a.

The hinge 30 passes through the second hole 221a of the second upper case 221 of the cover 20 such that the cover 20 is moveable with respect to the body 10. As shown in FIG. 3, the hinge 30 comprises a head portion 31 located in the first hole 211a and a body portion 32 located in the second hole 221a. Thus, the first and second upper cases 211 and 221 are connected via the hinge 30.

Note that the electronic apparatus 100 may be a mobile phone.

When the image capture device 11 is idle, the cover 20 is in the first position so that the image capture device 10 is covered by the first and second lower cases 212 and 222 of the cover 20. When the image capture device 11 is used, the cover 20 is in the second position so that the image capture device 11 is exposed by the cover 20.

As previously described, since the image capture device is exposed by the cover when used, it is not damaged when idle.

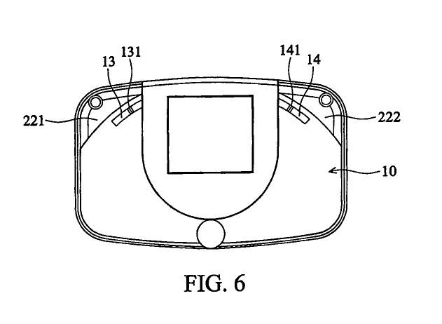

FIG. 6 depicts another embodiment of an electronic apparatus. The body 10 comprises a first protrusion 131 in the first groove 13 and a second protrusion 141 in the second groove 14 to limit the first and second rods 211b and 221c in the first position when the image capture device 11 is idle.

Furthermore, when the first and second protrusions 131 and 141 are formed in the first and second grooves 13 and 14, the hinge 30 provides torsional force to move the cover 20 toward the second position.

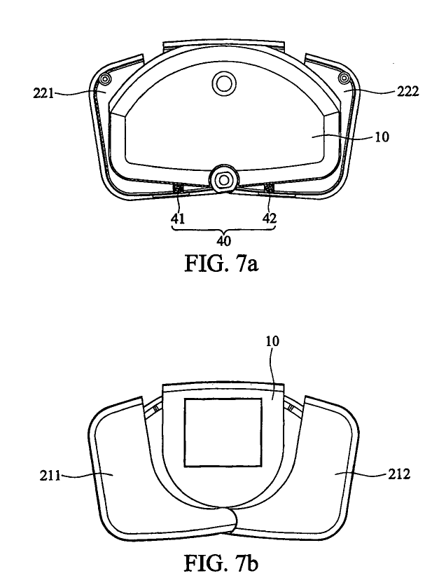

FIGS. 7a and 7b depict another embodiment of an electronic apparatus. The electronic apparatus further comprises two elastic members 40 including a first compression spring 41 and a second compression spring 42. The first compression spring 41 is disposed between the first lower case 221 and the body 10 to move the first lower case 221 toward the second position. The second compression spring 42 is disposed between the second lower case 222 and the body 10 to move the second lower case 222 toward the second position. When the cover 20 is in the first position, the first and second compression springs 41 and 42 are pressed by the body 10 and the cover 20. At the same time, the first and second rods 211b and 221c are stopped by the first and second protrusions 131 and 141 so that the cover 20 is kept in a closed state. If the first and second rods 211b and 221c are released by external force, the cover 20 is moved to the second position by the first and second compression springs 41 and 42 to be opened.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic apparatus comprising:
a body comprising an image capture device; and
a cover connected to the body to be moveable between a first position and a second position, wherein the image capture device is covered by the cover when the cover is in the first position, and the image capture device is exposed by the cover when the cover is in the second position.

2. The electronic apparatus as claimed in claim 1, further comprising a hinge disposed in the cover to pass through the body so that the cover is moveable with respect to the body.

3. The electronic apparatus as claimed in claim 2, wherein the cover comprises a first housing and a second housing connected to the first housing via the hinge.

4. The electronic apparatus as claimed in claim 3, wherein the first housing comprises a first upper case, and the second housing comprises a second upper case connected to the first upper case via the hinge.

5. The electronic apparatus as claimed in claim 4, wherein the first upper case comprises a first hole, the second upper case comprises a second hole, the hinge comprises a head portion located in the first hole and a body portion located in the second hole.

6. The electronic apparatus as claimed in claim 5, wherein the second upper case comprises a rotary shaft in which the second hole is formed.

7. The electronic apparatus as claimed in claim 6, wherein the body comprises a third hole in which the rotary shaft is located.

8. The electronic apparatus as claimed in claim 4, wherein the body comprises a first groove and a second groove, the first upper case comprises a first rod located in the first groove, the second upper case comprises a second rod located in the second groove, and the cover is moveable between the first position and the second position by moving the first and second rods in the first and second grooves respectively.

9. The electronic apparatus as claimed in claim 8, wherein the body comprises a first protrusion in the first groove and a second protrusion in the second groove to limit the first and second rods in the first position.

10. The electronic apparatus as claimed in claim 9, wherein the hinge provides torsional force to move the cover toward the second position.

11. The electronic apparatus as claimed in claim 4, wherein the first housing further comprises a first lower case combined with the first upper case, the second housing further comprises a second lower case combined with the second upper case, and the first and second lower cases are disposed on the same surface as the image capture device located.

12. The electronic apparatus as claimed in claim 11, further comprising:
a first spring disposed between the first lower case and the body to move the first lower case toward the second position; and
a second spring disposed between the second lower case and the body to move the second lower case toward the second position.

13. The electronic apparatus as claimed in claim 11, further comprising two screws, wherein each of the first and second upper cases comprises a post, each of the first and second lower cases comprises a guide hole, and the first and second upper cases are combined with the first and second lower cases by the screws entering the post through the guide hole respectively.

14. The electronic apparatus as claimed in claim 4, wherein the body comprises a display, and the first and second upper cases are disposed on the same surface as the display located.

15. The electronic apparatus as claimed in claim 14, wherein the first and second upper cases are formed in a manner such that the display is exposed by the first and second upper cases when the cover is in the first position.

16. The electronic apparatus as claimed in claim 2, wherein the hinge provides torsional force to move the cover toward the second position.

17. The electronic apparatus as claimed in claim 1, further comprising an elastic member disposed between the cover and the body to move the cover toward the second position.

18. The electronic apparatus as claimed in claim 17, wherein the elastic member is a compression spring.

19. The electronic apparatus as claimed in claim 1, wherein the electronic apparatus is a mobile phone.
